(19) United States
(12) Patent Application Publication
(10) Pub. No.: US 2024/0127604 A1
(43) Pub. Date: Apr. 18, 2024

(54) ROAD SURFACE INFORMATION COLLECTING DEVICE, ROAD SURFACE DETERIORATION DETECTING SYSTEM, AND ROAD SURFACE INFORMATION COLLECTING METHOD

(71) Applicant: Mitsubishi Electric Corporation, Tokyo (JP)

(72) Inventors: Ayako OYANAGI, Tokyo (JP); Yasuaki TAKIMOTO, Tokyo (JP); Takuya KONO, Tokyo (JP)

(73) Assignee: Mitsubishi Electric Corporation, Tokyo (JP)

(21) Appl. No.: 18/277,489

(22) PCT Filed: Apr. 7, 2021
(86) PCT No.: PCT/JP2021/014687

§ 371 Date: Aug. 16, 2023

(51) Int. Cl. G06V 20/56; G06V 10/60

(52) U.S. Cl. CPC G06V 20/588; G06V 10/60

(57) ABSTRACT

A road surface information collecting device, which is mounted on a vehicle to transmit a shot image acquired by shooting a road surface to a server to detect road surface deterioration, includes processing circuitry configured to: acquire the shot image of the road surface around the vehicle shot by a shooting device mounted on the vehicle; acquire shot area information regarding an area on the road surface shot in the acquired shot image; extract one or more candidate images acquired by shooting a certain area on the road surface out of acquired shot images on a basis of the acquired shot area information; select a selected image to be transmitted to the server out of the extracted candidate images; and transmit the selected image to the server.

### TECHNICAL FIELD

The present disclosure relates to a road surface information collecting device that is mounted on a vehicle and transmits a shot image acquired by shooting a road surface to a server that detects road surface deterioration, a road surface deterioration detecting system including the road surface information collecting device and the server, and a road surface information collecting method.

### BACKGROUND ART

A technology in which an in-vehicle device uploads a shot image acquired by shooting a road surface to a server, and the server analyzes the shot image uploaded from the in-vehicle device to detect road surface deterioration is conventionally known (for example, Patent Literature 1).

### CITATION LIST

### Patent Literatures

Patent Literature 1: JP 2013-139671 A

### SUMMARY OF INVENTION

### Technical Problem

In the conventional technology, when a server acquires a shot image not useful for analysis from an in-vehicle device, the server instructs reacquisition of a shot image because the acquired shot image is not useful. Here, the “image not useful for analysis” refers to an image that cannot be used for detecting road surface deterioration due to poor image quality, difficulty in determining a shape or a degree of the road surface deterioration and the like.

In contrast, when shooting the same area of the road surface a plurality of times, the in-vehicle device uploads a plurality of shot images acquired by shooting the same area of the road surface in an overlapping manner to the server. Then, there is a possibility that a part of the plurality of shot images is not used for detection of the road surface deterioration. In this manner, an image in which the shot area overlaps and is not used for detection of the road surface deterioration holds true for “image not useful for analysis” even when the image quality thereof is not poor.

The conventional technology has a problem of excessive load on communication bands caused by the upload of the shot image not useful for analysis from the in-vehicle device to the server such as a reacquisition instruction of an image from the server and reupload of the shot image by the in-vehicle device based on this, or upload of the shot image in which the shot area is overlapped by the in-vehicle device.

The present disclosure has been made to solve the above problems, and an object thereof is to provide a road surface information collecting device capable of reducing a communication band caused by upload of a shot image not useful for analysis from an in-vehicle device to a server.

### Solution to Problem

A road surface information collecting device according to the present disclosure is a road surface information collecting device that is mounted on a vehicle and transmits a shot image acquired by shooting a road surface to a server that detects road surface deterioration, the road surface information collecting device including an image acquiring unit that acquires the shot image of the road surface around the vehicle shot by a shooting device mounted on the vehicle, a shot area information acquiring unit that acquires shot area information regarding an area on the road surface shot in the shot image acquired by the image acquiring unit, an image managing unit that extracts one or more candidate images acquired by shooting a certain area on the road surface out of shot images acquired by the image acquiring unit on the basis of the shot area information acquired by the shot area information acquiring unit, an image selecting unit that selects a selected image to be transmitted to the server out of the candidate images extracted by the image managing unit, and a transmitting unit that transmits the selected image selected by the image selecting unit to the server.

### Advantageous Effects of Invention

The present disclosure can achieve reduction of a communication band due to upload of a shot image not useful for analysis from an in-vehicle device to a server.

### BRIEF DESCRIPTION OF DRAWINGS

FIG. 1 is a diagram illustrating a configuration example of a road surface deterioration detecting system according to a first embodiment.

FIG. 2 is a diagram illustrating a configuration example of the road surface information collecting device according to the first embodiment.

FIG. 3 is a diagram for explaining an example of a method by which a shot area information acquiring unit acquires shot area information in the first embodiment.

FIG. 4 is a diagram illustrating an example of information stored in a storage unit in the first embodiment.

FIG. 5 is a diagram for explaining an example of shot images shot areas whose partially overlap with each other in the first embodiment.

FIGS. 6A and 6B are diagrams for explaining an example of a candidate image and an image selecting score when an image selecting unit calculates the image selecting score by a proportion of the number of pixels in an estimated deteriorated area to the number of pixels in an entire area of the candidate image in the first embodiment.

FIG. 7 is a flowchart for explaining an operation of the road surface information collecting device according to the first embodiment.

FIG. 8 is a flowchart for explaining in detail an operation of an image managing unit at step ST3 in FIG. 7.

FIG. 9 is a flowchart for explaining in detail an operation of the image selecting unit at step ST4 in FIG. 7.

FIG. 10 is a diagram illustrating a configuration example of the road surface information collecting device when this is connected to a plurality of cameras in the first embodiment.

FIG. 11 is a diagram for explaining an example in which the plurality of cameras shoots the same area when the road surface information collecting device is connected to the plurality of cameras in the first embodiment.

FIGS. 12A and 12B are diagrams illustrating an example of a hardware configuration of the road surface information collecting device according to the first embodiment.

FIG. 13 is a diagram illustrating a configuration example of a road surface information collecting device according to a second embodiment.

FIG. 14 is a diagram for explaining an example in which the road surface information collecting device selects a selected image out of a plurality of candidate images in which an image selecting score is the highest in consideration of brightness when a camera shoots a road surface as an environmental condition in the second embodiment.

FIG. 15 is a diagram for explaining an example in which the road surface information collecting device selects a selected image out of a plurality of candidate images in which the image selecting score is the highest in consideration of a vibration state of the camera as the environmental condition in the second embodiment.

FIG. 16 is a diagram illustrating an example of shot area information stored in a storage unit in the second embodiment.

FIG. 17 is a flowchart for explaining an operation of the road surface information collecting device according to the second embodiment.

FIG. 18 is a flowchart for explaining in detail an operation of the image selecting unit at step ST15 in FIG. 17.

FIG. 19 is a diagram illustrating a configuration example of the road surface information collecting device when this is connected to an ECU in place of a sensor in the second embodiment.

### DESCRIPTION OF EMBODIMENTS

Hereinafter, embodiments of the present disclosure are described in detail with reference to the drawings.

### First Embodiment

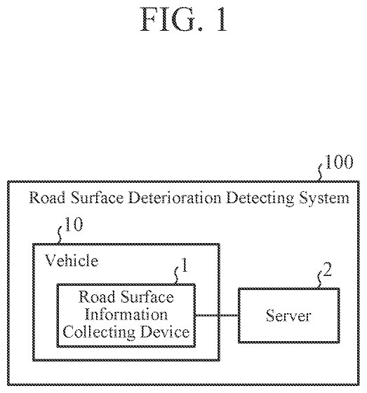

FIG. 1 is a diagram illustrating a configuration example of a road surface deterioration detecting system 100 according to a first embodiment.

A road surface information collecting device 1, which is an in-vehicle device, mounted on a vehicle 10 and a server 2 form the road surface deterioration detecting system 100. The road surface information collecting device 1 and the server 2 are connected to each other by wireless communication.

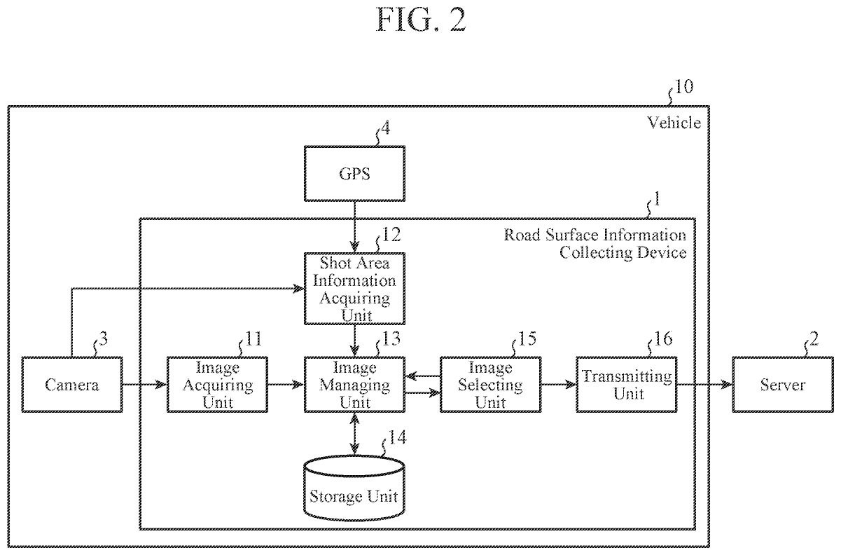

The road surface information collecting device 1 acquires a shot image acquired by shooting a road surface around the vehicle 10 from a camera 3 (refer to FIG. 2 to be described later), selects a shot image (hereinafter, referred to as a “selected image”) to be provided as a target of analysis for detecting road surface deterioration out of the acquired shot images, and transmits the selected image that is selected to the server 2. That is, the road surface information collecting device 1 uploads the selected image to the server 2.

The server 2 analyzes the selected image transmitted from the road surface information collecting device 1, and performs road surface deterioration detection processing of detecting deterioration of the road surface such as a depression or a crack. For example, the server 2 performs known image recognition processing or the like on the selected image, analyzes a shape or a degree of the road surface deterioration, and detects whether or not the road surface is deteriorated.

Information regarding the deterioration of the road surface detected by the server 2 by performing the road surface deterioration detection processing is output to, for example, a management device (not illustrated), and is used in the management device as information for checking a site or information for creating a repair plan.

FIG. 2 is a diagram illustrating a configuration example of the road surface information collecting device 1 according to the first embodiment.

The road surface information collecting device 1 is mounted on the vehicle 10.

The road surface information collecting device 1 is connected to the server 2, the camera 3, and a global positioning system (GPS) 4.

The camera 3 is a shooting device mounted on the vehicle 10, and shoots the road surface around the vehicle 10 such as a road surface of a road on which the vehicle 10 travels. In the first embodiment, the camera 3 is mounted outside the road surface information collecting device 1, but this is merely an example, and the camera 3 may be mounted on the road surface information collecting device 1.

The GPS 4 is mounted on the vehicle 10 and acquires a current position of the vehicle 10. In the first embodiment, the GPS 4 is mounted outside the road surface information collecting device 1, but this is merely an example, and the GPS 4 may be mounted on the road surface information collecting device 1.

The road surface information collecting device 1 is provided with an image acquiring unit 11, a shot area information acquiring unit 12, an image managing unit 13, a storage unit 14, an image selecting unit 15, and a transmitting unit 16.

The image acquiring unit 11 acquires, from the camera 3, a shot image of the road surface around the vehicle 10 shot by the camera 3. The image acquiring unit 11 acquires the shot image in units of frames.

The image acquiring unit 11 outputs the acquired shot image to the image managing unit 13.

The shot area information acquiring unit 12 acquires information regarding an area on the road surface shot in the shot image acquired by the image acquiring unit 11 (hereinafter, referred to as “shot area information”).

In the first embodiment, the shot area information is information capable of specifying which area on the road surface is shot in the shot image.

When information indicating that the road surface is shot (hereinafter, referred to as “shooting notifying information”) is output from the camera 3, the shot area information acquiring unit 12 acquires the shot area information.

In the first embodiment, for example, the camera 3 outputs the shooting notifying information to the shot area information acquiring unit 12 at a timing of outputting the shot image to the image acquiring unit 11.

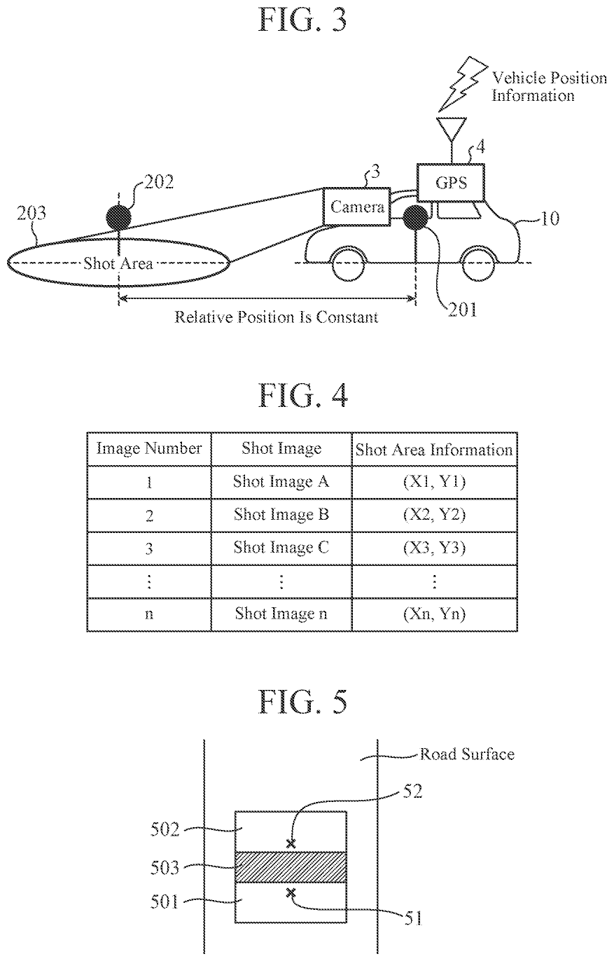

Herein, FIG. 3 is a diagram for explaining an example of a method by which the shot area information acquiring unit 12 acquires the shot area information in the first embodiment.

For example, the shot area information acquiring unit 12 specifies the area on the road surface shot in the shot image on the basis of information regarding the camera 3 and a current position of the vehicle 10. The information regarding the camera 3 is, for example, an installation position and an angle of view of the camera 3. The information regarding the camera 3 is determined in advance, and is stored, for example, in a place that can be referred to by the shot area information acquiring unit 12. The shot area information acquiring unit 12 acquires information regarding the current position of the vehicle 10 from the GPS 4.

Since the installation position and the angle of view of the camera 3 are known in advance, when the current position (represented by 201 in FIG. 3) of the vehicle 10 is known, the shot area information acquiring unit 12 can specify the center (represented by 202 in FIG. 3) of the shot area of the camera 3 on the basis of the current position of the vehicle 10. A relative position of the current position of the vehicle 10 and the center of the shot area of the camera 3 is always constant. In the first embodiment, the center of the shot area of the camera 3 is a point on a real space, and is represented by, for example, coordinate values that can be mapped on a map.

Since the shot area that can be shot by the camera 3 is always constant, the shot area information acquiring unit 12 can grasp the shot area (represented by 203 in FIG. 3) of the camera 3 from the specified center of the shot area of the camera 3.

Every time the shooting notifying information is output from the camera 3, in other words, every time the camera 3 shoots the shot image, the shot area information acquiring unit 12 acquires the shot area information.

The shot area information acquiring unit 12 does not need to acquire the current position of the vehicle 10 from the GPS 4 every time the shooting notifying information is output from the camera 3. For example, the shot area information acquiring unit 12 may acquire the current position of the vehicle 10 by acquiring vehicle speed information, and calculating a distance traveled by the vehicle 10 on the basis of the acquired vehicle speed information and an elapsed time from when the current position information of the vehicle 10 is acquired from the GPS 4 last time. In this case, the shot area information acquiring unit 12 may acquire the vehicle speed information from, for example, a vehicle speed sensor mounted on the vehicle 10.

The shot area information acquiring unit 12 outputs coordinates of the specified center of the shot area of the camera 3 to the image managing unit 13 as the shot area information.

In the first embodiment, when the shooting notifying information is output from the camera 3, the shot area information acquiring unit 12 acquires the shot area information; however, this is merely an example. For example, when the image acquiring unit 11 acquires the shot image from the camera 3, this may notify the shot area information acquiring unit 12 that the shot image is acquired, and the shot area information acquiring unit 12 may acquire the shot area information upon receiving the notification.

For example, when the vehicle 10 stops at a traffic light or the like, and the image acquiring unit 11 acquires the shot image from the camera 3, this can notify the shot area information acquiring unit 12 that the shot image is acquired, as described above. This is because, when the vehicle 10 stops, the vehicle 10 does not travel and the position of the vehicle 10 does not change in a time from when the camera 3 shoots the road surface to when the image acquiring unit 11 acquires the shot image. If the position of the vehicle 10 changes in the time from when the camera 3 shoots the road surface to when the image acquiring unit 11 acquires the shot image, the shot area information acquiring unit 12 cannot correctly acquire the shot area information for the shot image acquired by the image acquiring unit 11, in other words, the shot area information when the camera 3 shoots the road surface.

The image managing unit 13 manages the shot image output from the image acquiring unit 11 and the shot area information output from the shot area information acquiring unit 12 in association with each other. Specifically, the image managing unit 13 stores the shot image and the shot area information in the storage unit 14 in association with each other.

Here, FIG. 4 is a diagram illustrating an example of information stored in the storage unit 14 in the first embodiment.

The image managing unit 13 stores the shot image and the shot area information in the storage unit 14 in association with each other as illustrated in FIG. 4. At that time, the image managing unit 13 assigns an image number to the shot image. The image managing unit 13 assigns the image number to the shot image acquired from the image acquiring unit 1I in the order of acquisition from the image acquiring unit 11, in other words, in the order of acquisition by the image acquiring unit 11 from the camera 3. In FIG. 4, the image managing unit 13 assigns image numbers “1” to “n” in ascending order to the shot images acquired from the image acquiring unit 11 in the order of acquisition from the image acquiring unit 11.

When there is an image output request from the image selecting unit 15, the image managing unit 13 extracts the shot image (hereinafter, referred to as a “candidate image”) from the storage unit 14 and outputs the same to the image selecting unit 15.

More specifically, when there is the image output request, the image managing unit 13 extracts one or more candidate images in which a certain area on the road surface is shot out of the shot images stored in the storage unit 14 on the basis of the shot area information stored in association with the shot image in the storage unit 14, and outputs the same to the image selecting unit 15.

That is, the image managing unit 13 extracts the shot image stored in the storage unit 14 as the candidate image on the basis of the shot area information. At that time, when there is a plurality of shot images in which the same area is shot, the image managing unit 13 collectively extracts the plurality of shot images in which the same area is shot as the candidate images. A method of determining the same area by the image managing unit 13 is described later.

When outputting the candidate image to the image selecting unit 15, the image managing unit 13 outputs the shot area information in association with the candidate image.

The candidate image output by the image managing unit 13 to the image selecting unit 15 is the shot image that serves as a candidate to be transmitted to the server 2. The image selecting unit 15 selects the shot image (hereinafter, referred to as the “selected image”) to be transmitted to the server 2 out of the candidate images. The image selecting unit 15 is described later in detail.

Processing by which the image managing unit 13 extracts the candidate image is specifically described.

First, the image managing unit 13 determines whether or not there is a request for outputting an image from the image selecting unit 15.

The image selecting unit 15 outputs a signal (hereinafter, referred to as an “image output request signal”) for requesting the candidate image to the image managing unit 13 at a preset cycle. When acquiring the image output request signal, the image managing unit 13 determines that there is a request for outputting the candidate image from the image selecting unit 15. In the first embodiment, the request for the candidate image issued by the image selecting unit 15 to the image managing unit 13 is also referred to as an “image output request”.

When determining that there is the image output request from the image selecting unit 15, the image managing unit 13 extracts the oldest shot image (hereinafter, referred to as an “oldest image”) stored in the storage unit 14, and outputs the extracted oldest image to the image selecting unit 15 as the candidate image.

The image managing unit 13 may specify the oldest image from, for example, the image number assigned to the shot image. It is assumed that information regarding shot date and time is assigned to the shot image, and the image managing unit 13 may specify the oldest image stored in the storage unit 14 from the information regarding the shot date and time.

Next, the image managing unit 13 extracts the shot image (hereinafter, referred to as a “same area image”) in which the same area as that of the oldest image is shot, in other words, the same area image the shot area of which is the same as that of the oldest image, out of the shot images stored in the storage unit 14, and outputs the extracted same area image to the image selecting unit 15 as the candidate image.

Here, the expression that “the same area is shot” includes not only that the shot areas completely coincide with each other but also that the shot areas overlap with each other in a certain range or more.

For example, the expression that “a shot area of a shot image A and a shot area of a shot image B are the same” may mean that the shot area of the shot image A and the shot area of the shot image B completely coincide with each other, that the shot area of the shot image A and the shot area of the shot image B overlap with each other by half or more, or that the shot area of the shot image A and the shot area of the shot image B partially overlap with each other. A degree of overlap of the shot areas for regarding that “the same shot area is shot” is determined in advance.

FIG. 5 is a diagram for explaining an example of the shot images whose the shot areas partially overlap with each other in the first embodiment.

FIG. 5 illustrates an example in which the shot area of the shot image A and the shot area of the shot image B partially overlap with each other as an example. In FIG. 5, the shot area of the shot image A is represented by 501, and the shot area of the shot image B is represented by 502. In FIG. 5, an overlapping area in which the shot area of the shot image A and the shot area of the shot image B overlap with each other is represented by 503. In FIG. 5, the center of the shot area of the shot image A is represented by 51, and the center of the shot area of the shot image B is represented by 52.

In the first embodiment, when a size of the overlapping area represented by 503 in FIG. 5 is equal to or larger than a certain size, it is regarded that “the same shot area is shot” in the shot image A and the shot image B.

The fact that “the same shot area is shot” can be determined on the basis of the shot area information stored in the storage unit 14 in association with the shot images, that is, on the basis of a distance between the centers of the shot areas.

In the example illustrated in FIG. 5, for example, when the distance between the center (51 in FIG. 5) of the shot area of the shot image A and the center (52 in FIG. 5) of the shot area of the shot image B is shorter than a threshold (hereinafter referred to as an “overlap determining threshold”) set in advance, it is regarded that “the same shot area is shot” in the shot image A and the shot image B.

For example, when the center of the shot area of the oldest image coincides with the center of the shot area of the shot image stored in the storage unit 14, or when the distance between the center of the shot area of the oldest image and the center of the shot area of the shot image stored in the storage unit 14 is shorter than the overlap determining threshold, the image managing unit 13 determines that the same shot area is shot in the oldest image and the shot image stored in the storage unit 14.

In the first embodiment, it is assumed that the shot images in which the same shot area is shot may be continuously output from the camera 3 and stored in the storage unit 14 when the vehicle 10 stops, when the vehicle 10 travels at a low speed, or when the speed of the vehicle 10 is low with respect to the shooting cycle of the camera 3, for example.

For example, when the image managing unit 13 extracts the oldest image, this temporarily stores the oldest image and the shot area information associated with the oldest image. The image managing unit 13 compares the temporarily stored shot area information with the shot area information associated with the shot image stored in the storage unit 14, and determines that the shot image of which the center of the shot area coincides with the center of the shot area of the oldest image, or the shot image of which the center of the shot area is at a distance shorter than the overlap determining threshold from the center of the shot area of the oldest image out of the shot images stored in the storage unit 14 as the same area image. The image managing unit 13 extracts the same area image as the candidate image, and outputs the same to the image selecting unit 15.

The image managing unit 13 repeats extracting the candidate image and outputting the extracted candidate image to the image selecting unit 15 until all of the same area images stored in the storage unit 14 are extracted as the candidate images.

Information regarding the candidate image extracted by the image managing unit 13 is deleted from the storage unit 14.

When the image managing unit 13 finishes extracting and outputting all of the candidate images, this outputs a signal (hereinafter, referred to as an “output end signal”) to the image selecting unit 15 notifying the same that the output of the candidate image is finished.

The storage unit 14 stores the shot image which is assigned with the image number and associated with the shot area information.

In the first embodiment, the storage unit 14 is provided in the road surface information collecting device 1, but this is merely an example. The storage unit 14 may be provided outside the road surface information collecting device 1 at a place that can be referred to by the road surface information collecting device 1.

The image selecting unit 15 selects the candidate image (hereinafter, referred to as the “selected image”) to be transmitted to the server 2 out of the candidate images extracted by the image managing unit 13.

In more detail, the image selecting unit 15 first issues the image output request by outputting the image output request signal to the image managing unit 13 at a preset cycle.

After issuing the image output request, the image selecting unit 15 temporarily stores the candidate image output from the image managing unit 13 until the output end signal is output from the image managing unit 13.

When the output end signal is output from the image managing unit 13, the image selecting unit 15 selects the selected image out of the temporarily stored candidate images.

The image selecting unit 15 performs detection processing as to whether or not the road surface shot in the candidate image is deteriorated on the candidate image temporarily stored, in other words, the candidate image extracted by the image managing unit 13, and selects the selected image on the basis of a result of the detection processing. The detection processing performed by the image selecting unit 15 is simpler processing than the road surface deterioration detection processing performed by the server 2, and is so-called “road surface deterioration detection trial processing”. Prior to the road surface deterioration detection processing performed by the server 2, the image selecting unit 15 narrows down the shot images in which the deteriorated road surface is estimated to be shot, the shot images supposed to be useful for analysis in the road surface deterioration detection processing.

First, the image selecting unit 15 determines whether there is one candidate image or a plurality of candidate images output from the image managing unit 13.

When there is a plurality of candidate images output from the image managing unit 13, the image selecting unit 15 performs the “road surface deterioration detection trial processing” for every candidate image.

In the “road surface deterioration detection trial processing”, the image selecting unit 15 extracts the area (hereinafter, referred to as an “estimated deteriorated area”) in which the road surface deterioration is estimated to be shot out of an entire area of the candidate image. For example, the image selecting unit 15 extracts an outline of the area in which the road surface deterioration is estimated to be shot in the candidate image using a known edge detecting technology. For example, when a pixel having luminance lower than that of surrounding pixels partially appears in the pixels of the candidate image, there is a possibility that an area of the pixel having low luminance is the area in which the road surface deterioration is shot.

As a result of the “road surface deterioration detection trial processing”, when the road surface deterioration is detected, in other words, when the estimated deteriorated area can be extracted from the candidate image, the image selecting unit 15 calculates an image selecting score for the candidate image. In the first embodiment, the image selecting score indicates a degree to which the candidate image is supposed to be useful for analysis in the road surface deterioration detection processing performed by the server 2. The larger the image selecting score, the more useful the candidate image for which the image selecting score is calculated is supposed for analysis in the road surface deterioration detection processing performed by the server 2.

Here, a method of calculating the image selecting score by the image selecting unit 15 is described with some specific examples.

For example, the image selecting unit 15 calculates a proportion of the number of pixels in the estimated deteriorated area to the number of pixels in the entire area of the candidate image as the image selecting score.

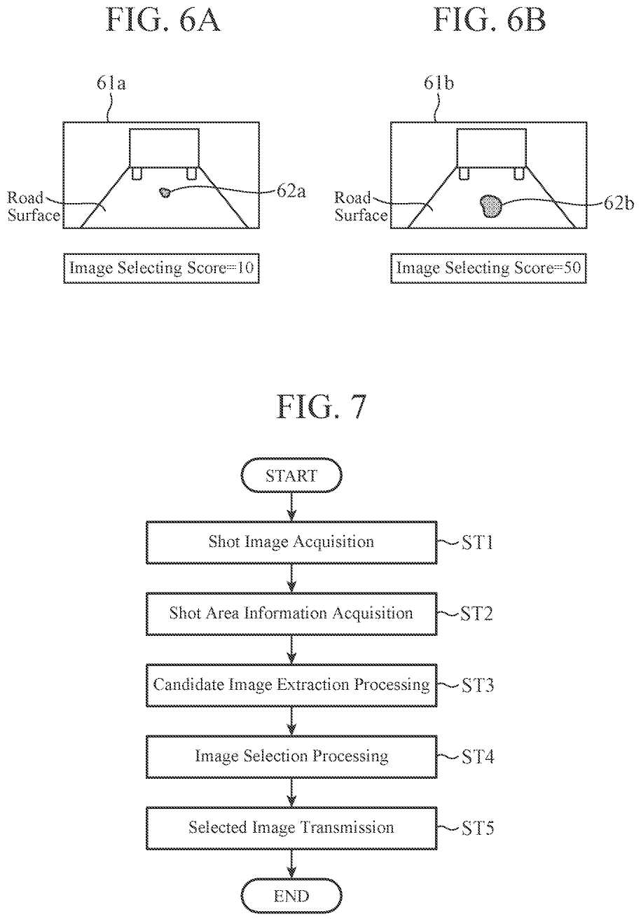

FIGS. 6A and 6B are diagrams for explaining an example of the candidate image and the image selecting score when the image selecting unit 15 calculates the image selecting score by the proportion of the number of pixels in the estimated deteriorated area to the number of pixels in the entire area of the candidate image in the first embodiment.

In the candidate image (represented by 61a in FIG. 6A) illustrated in FIG. 6A, a portion estimated to be the road surface deterioration (represented by 62a in FIG. 6A) is shot from a position at a distance, and a proportion occupied by the estimated deteriorated area to the entire area of the candidate image is small. In FIG. 6A, the image selecting unit 15 calculates the image selecting score as “10” on the basis of the number of pixels in the entire area of the candidate image and the number of pixels in the estimated deteriorated area.

In contrast, in the candidate image (represented by 61b in FIG. 6B) illustrated in FIG. 6B, a portion estimated to be the road surface deterioration (represented by 62b in FIG. 6B) is shot from a close position, and a proportion occupied by the estimated deteriorated area to the entire area of the candidate image is larger than the proportion occupied by the estimated deteriorated area to the entire area of the candidate image in FIG. 6A. In FIG. 6B, the image selecting unit 15 calculates the image selecting score as “50” on the basis of the number of pixels in the entire area of the candidate image and the number of pixels in the estimated deteriorated area.

The image selecting unit 15 may calculate the image selecting score from sharpness of the outline of the estimated deteriorated area in the candidate image, in other words, sharpness of an edge of the estimated deteriorated area, for example. A calculation formula for calculating the image selecting score from the sharpness of the edge of the estimated deteriorated area is set in advance. In the calculation formula, a calculation formula is set in such a manner that the image selecting score increases as the edge of the estimated deteriorated area is sharper.

When the estimated deteriorated area cannot be extracted from the candidate image as a result of the “road surface deterioration detection trial processing”, the image selecting unit 15 discards the candidate image. When the estimated deteriorated area is not extracted from the candidate image, it is estimated that the road surface deterioration is not shot in the candidate image. The candidate image in which the road surface deterioration is not shot does not need to be a detection target of the road surface deterioration. That is, the candidate image in which the road surface deterioration is not shot does not need to be selected as the selected image to be transmitted to the server 2.

After performing the “road surface deterioration detection trial processing” on all of the plurality of candidate images and calculating the image selecting score for the candidate image from which the estimated deteriorated area is extracted, the image selecting unit 15 selects the candidate image in which the calculated image selecting score is the highest as the selected image.

For example, when a plurality of candidate images (61a in FIGS. 6A and 61b in FIG. 6B) as illustrated in FIGS. 6A and 6B are output from the image managing unit 13, the image selecting unit 15 selects the candidate image illustrated in FIG. 6B having the higher image selecting score as the selected image.

In this manner, the image selecting unit 15 extracts the estimated deteriorated area by performing the “road surface deterioration detection trial processing”, and selects, as the selected image, the candidate image having the higher image selecting score calculated on the basis of the size of the extracted estimated deteriorated area, in other words, the candidate image in which the estimated deteriorated area is shot larger out of the candidate images. It can be said that it is easier to detect the shape, degree or the like of the road surface deterioration in the candidate image in which the estimated deteriorated area is shot larger. That is, it can be said that the candidate image in which the estimated deteriorated area is shot larger is the shot image more useful for analysis in the road surface deterioration detection processing performed by the server 2.

For example, the image selecting unit 15 extracts the estimated deteriorated area by performing the “road surface deterioration detection trial processing”, and selects, when the image selecting score is calculated from the sharpness of the edge of the estimated deterioration area, as the selected image, the candidate image having the sharper edge of the estimated deteriorated area, in other words, the candidate image in which the outline of the estimated deteriorated area is shot sharper out of the plurality of candidate images. It can be said that it is easier to detect the shape, degree or the like of the road surface deterioration in the candidate image in which the outline of the estimated deteriorated area is shot sharper. That is, it can be said that the candidate image in which the outline of the estimated deteriorated area is shot sharper is the shot image more useful for analysis in the road surface deterioration detection processing performed by the server 2.

The image selecting unit 15 can transmit the shot image (selected image) useful for the road surface deterioration detection processing to the server 2 by performing the “road surface deterioration detection trial processing”, which is simple road surface deterioration detection processing, to narrow down the selected images to be transmitted to the server 2. The selected image is transmitted to the server 2 by the transmitting unit 16.

In this manner, when there is a plurality of candidate images, the image selecting unit 15 calculates the image selecting score for each candidate image, and selects the selected image on the basis of the calculated image selecting score. The image selecting unit 15 outputs the selected image that is selected to the transmitting unit 16.

In contrast, when there is only one candidate image output from the image managing unit 13, the image selecting unit 15 performs the “road surface deterioration detection trial processing” on this one candidate image.

When extracting the estimated deteriorated area from the candidate image as a result of performing the “road surface deterioration detection trial processing” on one candidate image, the image selecting unit 15 selects this one candidate image as the selected image. The image selecting unit 15 outputs the selected image that is selected to the transmitting unit 16.

When the estimated deteriorated area is not extracted from the candidate image as a result of performing the “road surface deterioration detection trial processing” on one candidate image, the image selecting unit 15 discards the candidate image and does not select the selected image.

When outputting the selected image to the transmitting unit 16, the image selecting unit 15 outputs the shot area information in association with the selected image.

When outputting the selected image to the transmitting unit 16, the image selecting unit 15 deletes the temporarily stored candidate image.

The transmitting unit 16 transmits the selected image selected by the image selecting unit 15 to the server 2.

The transmitting unit 16 outputs the selected image in association with the shot area information.

An operation of the road surface information collecting device 1 according to the first embodiment is described.

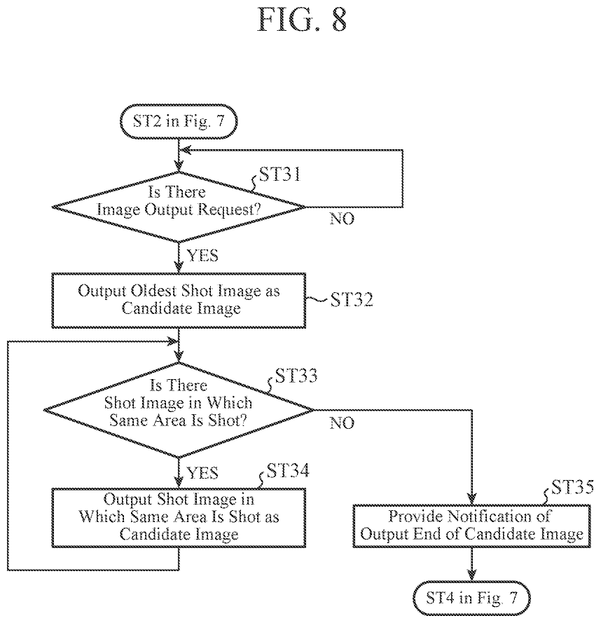

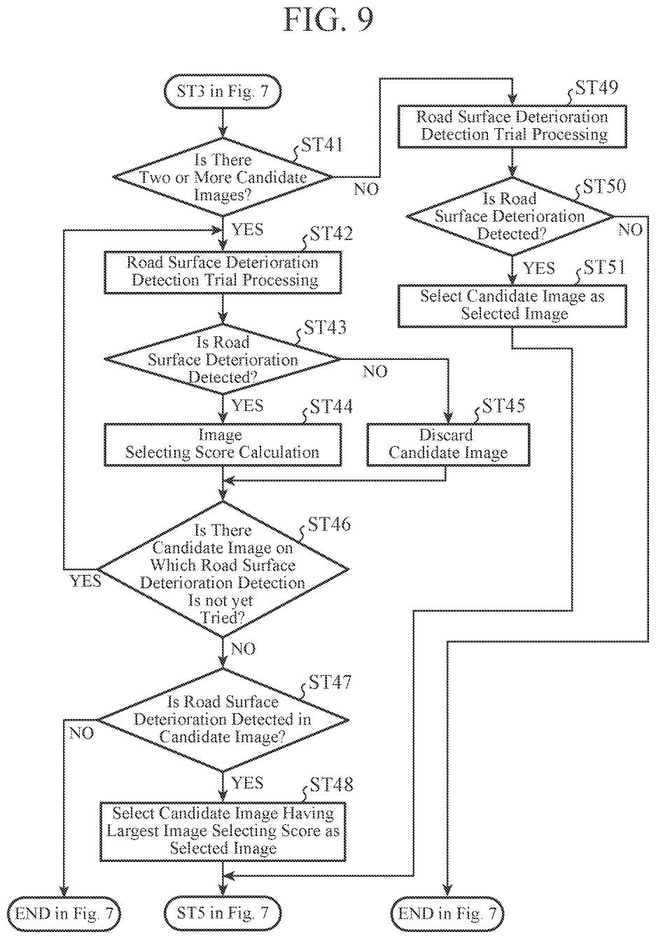

FIG. 7 is a flowchart for explaining the operation of the road surface information collecting device 1 according to the first embodiment.

The image acquiring unit 11 acquires, from the camera 3, the shot image of the road surface around the vehicle 10 shot by the camera 3 (step ST1).

The image acquiring unit 11 outputs the acquired shot image to the image managing unit 13.

The shot area information acquiring unit 12 acquires the shot area information regarding the area on the road surface shot in the shot image acquired by the image acquiring unit 11 at step ST1 (step ST2).

The shot area information acquiring unit 12 outputs the acquired shot area information to the image managing unit 13.

The image managing unit 13 manages the shot image output from the image acquiring unit 11 at step ST1 and the shot area information output from the shot area information acquiring unit 12 at step ST2 in association with each other. Specifically, the image managing unit 13 stores the shot image and the shot area information in the storage unit 14 in association with each other.

When there is the image output request from the image selecting unit 15, the image managing unit 13 extracts the candidate image from the storage unit 14 and outputs the same to the image selecting unit 15 (step ST3).

The image selecting unit 15 selects the selected image to be transmitted to the server 2 out of the candidate images extracted by the image managing unit 13 at step ST3 (step ST4).

The image selecting unit 15 issues the image output request by outputting the image output request signal to the image managing unit 13 at a preset cycle before performing the processing at step ST4. The image managing unit 13 performs the processing at step ST3 described above in response to the image output request signal.

The image selecting unit 15 outputs the selected image to the transmitting unit 16.

The transmitting unit 16 transmits the selected image selected by the image selecting unit 15 at step ST4 to the server 2 (step ST5).

FIG. 8 is a flowchart for explaining in detail an operation of the image managing unit 13 at step ST3 in FIG. 7.

The image managing unit 13 determines whether or not there is the image output request from the image selecting unit 15 (step ST31) and stands by until the image output request is issued (in a case of “NO” at step ST31).

When determining that the image output request is issued from the image selecting unit 15 (in a case of “YES” at step ST31), the image managing unit 13 extracts the oldest image stored in the storage unit 14, and outputs the extracted oldest image to the image selecting unit 15 as the candidate image (step ST32).

Next, the image managing unit 13 determines whether or not there is the same area image in which the same area as that in the oldest image is shot out of the shot images stored in the storage unit 14 on the basis of the shot area information stored in the storage unit 14 in association with the shot images (step ST33).

When there is the same area image (in a case of “YES” at step ST33), the image managing unit 13 extracts the same area image, and outputs the extracted same area image to the image selecting unit 15 as the candidate image (step ST34).

The image managing unit 13 repeats the processing at steps ST33 to ST34 until all of the same area images stored in the storage unit 14 are extracted as the candidate images.

When the extraction and output of all of the candidate images stored in the storage unit 14 are finished, and it is determined that there is no same area image at step ST33 (in a case of “NO” at step ST33), the image managing unit 13 outputs the output end signal to the image selecting unit 15 notifying the same that the output of the candidate image is finished (step ST35).

FIG. 9 is a flowchart for explaining in detail an operation of the image selecting unit 15 at step ST4 in FIG. 7.

When the output end signal is output from the image managing unit 13, the image selecting unit 15 performs processing illustrated in the flowchart in FIG. 9.

The image selecting unit 15 determines whether there is one candidate image or a plurality of candidate images output from the image managing unit 13 at step ST3 in FIG. 7 (step ST41).

When there is a plurality of candidate images output from the image managing unit 13 (in a case of “YES” at step ST41), the image selecting unit 15 performs the “road surface deterioration detection trial processing” for every candidate image (step ST42).

As a result of the “road surface deterioration detection trial processing”, when the road surface deterioration is detected, in other words, when the estimated deteriorated area can be extracted from the candidate image (in a case of “YES” at step ST43), the image selecting unit 15 calculates the image selecting score for the candidate image (step ST44). The operation of the image selecting unit 15 proceeds to processing at step ST46.

When the estimated deteriorated area cannot be extracted from the candidate image as a result of the “road surface deterioration detection trial processing” (in a case of “NO” at step ST43), the image selecting unit 15 discards the candidate image (step ST45). The operation of the image selecting unit 15 proceeds to processing at step ST46.

While there is the candidate image on which the “road surface deterioration detection trial processing” is not yet performed (in a case of “YES” at step ST46), the image selecting unit 15 repeats the operation at steps ST42 to ST45.

As a result of performing the “road surface deterioration detection trial processing” on all of the plurality of candidate images, the image selecting unit 15 determines whether or not the estimated deteriorated area is extracted and the image selecting score is calculated (step ST47).

As a result of performing the “road surface deterioration detection trial processing” on all of the plurality of candidate images, when no road surface deterioration is detected in all of the plurality of candidate images (in a case of “NO” at step ST47), the image selecting unit 15 finishes the operation illustrated in the flowchart in FIG. 9, and the road surface information collecting device 1 finishes the operation illustrated in the flowchart in FIG. 7. That is, the selected image is not transmitted from the road surface information collecting device 1 to the server 2.

When the road surface deterioration is detected in at least one of the plurality of candidate images as a result of performing the “road surface deterioration detection trial processing” on all of the plurality of candidate images, and the image selecting score is calculated for the candidate image from which the estimated deteriorated area is extracted (in a case of “YES” at step ST47), the image selecting unit 15 selects the candidate image in which the calculated image selecting score is the highest as the selected image (step ST48).

In contrast, when there is only one candidate image output from the image managing unit 13 (in a case of “NO” at step ST41), the image selecting unit 15 performs the “road surface deterioration detection trial processing” on this one candidate image (step ST49).

When the estimated deteriorated area is extracted from the candidate image, in other words, when the road surface deterioration is detected from the candidate image as a result of performing the “road surface deterioration detection trial processing” on one candidate image (in a case of “YES” at step ST50), the image selecting unit 15 selects this one candidate image as the selected image (step ST51). The image selecting unit 15 outputs the selected image that is selected to the transmitting unit 16.

When the estimated deteriorated area is not extracted from the candidate image, in other words, when the road surface deterioration is not detected from the candidate image as a result of performing the “road surface deterioration detection trial processing” on one candidate image (in a case of “NO” at step ST50), the image selecting unit 15 discards the candidate image and does not select the selected image. The image selecting unit 15 finishes the operation illustrated in the flowchart in FIG. 9, and the road surface information collecting device 1 finishes the operation illustrated in the flowchart in FIG. 7. That is, the selected image is not transmitted from the road surface information collecting device 1 to the server 2.

In this manner, the road surface information collecting device 1 acquires the shot image of the road surface around the vehicle 10 shot by the camera 3, and extracts one or more candidate images in which a certain area is shot out of the shot images on the basis of the shot area information acquired on the basis the shot image. The road surface information collecting device 1 selects the selected image to be transmitted to the server 2 out of one or more candidate images, and transmits the selected image that is selected to the server 2.

For example, when the camera 3 shoots a certain area a plurality of times, that is, when the camera 3 shoots the same area a plurality of times, when there is the road surface deterioration, it is assumed that the road surface deterioration is also overlappingly shot.

When the server 2 detects road surface deterioration in the road surface deterioration detection processing, only one shot image in which the road surface deterioration is shot is sufficient. If a plurality of shot images in which the same area is shot is transmitted to the server 2, there is a possibility that a part of the plurality of shot images transmitted to the server 2 is the shot image not necessarily used for the road surface deterioration detection processing. That is, there is a possibility that a part of the plurality of shot images transmitted to the server 2 is the shot image not useful for analysis in the road surface deterioration detection processing.

In contrast, when there is a plurality of shot images in which the same area is shot, the road surface information collecting device 1 according to the first embodiment selects the selected image out of them and transmits only the selected image to the server 2. In this manner, the road surface information collecting device 1 does not transmit the shot image, in which the same area is overlappingly shot, not useful for analysis in the road surface detection processing in the server 2. As a result, the road surface information collecting device 1 can reduce a communication band for transmitting the shot image not useful for analysis.

When selecting the selected image to be transmitted to the server 2, the road surface information collecting device 1 performs the “road surface deterioration detection trial processing”, and performs simple road surface deterioration detection processing as processing before the server 2 performs the road surface deterioration detection processing. The road surface information collecting device 1 does not select the shot image in which it is estimated that the road surface deterioration is not shot as a result of performing the “road surface deterioration detection trial processing” as the selected image. The shot image in which it is estimated that the road surface deterioration is not shot as a result of performing the “road surface deterioration detection trial processing” is not transmitted to the server 2. The shot image in which the road surface deterioration is not shot is not required for the road surface deterioration detection processing in the server 2 from the first. That is, it can be said that the shot image in which the road surface deterioration is not shot is the shot image not useful for analysis in the road surface deterioration detection processing in the server 2. The road surface information collecting device 1 can reduce the communication band for transmitting the shot image not useful for analysis by not selecting the shot image in which it is estimated that the road surface deterioration is not shot as a result of performing the “road surface deterioration detection trial processing”.

Furthermore, when the road surface deterioration is detected as a result of performing the “road surface deterioration detection trial processing” and there is a plurality of candidate images in which the same area is shot when selecting the selected image to be transmitted to the server 2, the road surface information collecting device 1 calculates the image selecting score and selects the shot image in which the image selecting score is the highest as the selected image. In this manner, the road surface information collecting device 1 transmits, to the server 2, the selected image supposed to be most useful for analysis in the road surface deterioration detection processing in the server 2. As a result, the road surface information collecting device 1 can reduce occurrence of a situation in which it is necessary to transmit a retransmission instruction of the shot image to the server 2 for the reason that it is difficult to analyze the shot image when the road surface deterioration detection processing is performed on the basis of the transmitted shot image, for example. As a result, the road surface information collecting device 1 can reduce a communication band for the retransmission instruction of the shot image transmitted from the server 2 due to the transmission of the shot image not useful for the analysis.

As described above, in the road surface deterioration detecting system 100, the road surface information collecting device 1 can achieve the reduction of the communication band caused by upload of the shot image not useful for analysis in the road surface deterioration detection processing in the server 2 from the in-vehicle device (road surface information collecting device 1) to the server 2. The communication band in which the selected image selected by the road surface information collecting device 1 is uploaded is sufficient for the communication band used for uploading the shot image from the road surface information collecting device 1 to the server 2.

In the first embodiment, the road surface information collecting device 1 is connected to one camera 3, but this is merely an example.

The road surface information collecting device 1 may be connected to a plurality of cameras.

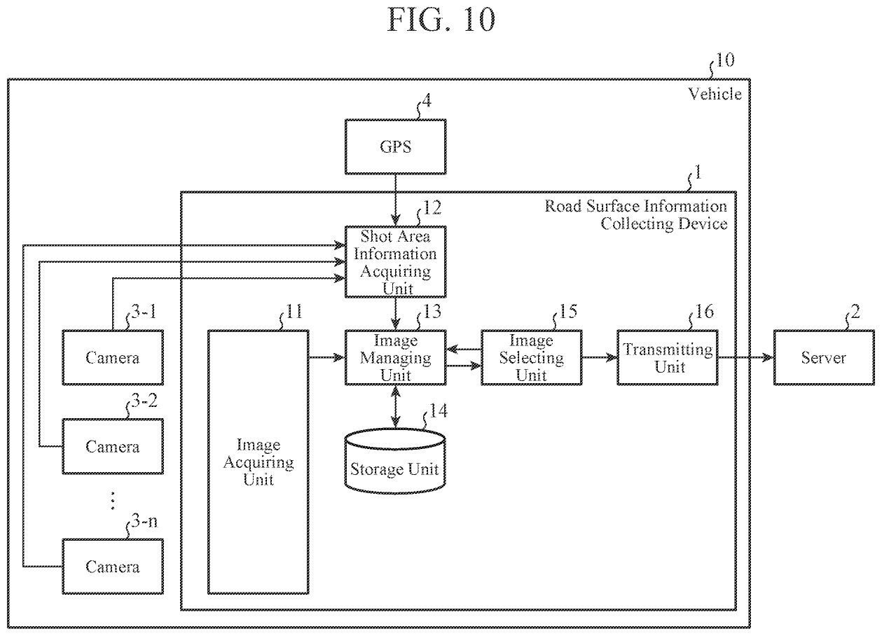

FIG. 10 is a diagram illustrating a configuration example of the road surface information collecting device 1 when this is connected to a plurality of cameras 3-1 to 3-n in the first embodiment.

The road surface information collecting device 1 illustrated in FIG. 1 is different from the road surface information collecting device 1 illustrated in FIG. 10 only in the number of connected cameras.

The plurality of cameras 3-1 to 3-n is supposed to be mounted on the vehicle 10. Installation positions of the plurality of cameras 3-1 to 3-n can be set to appropriate positions. For example, a camera that shoots the road surface ahead of the vehicle 10 and a camera that shoots the road surface behind the vehicle 10 may be installed on the front and rear sides of the vehicle 10, respectively, and a camera that shoots the road surface on the left side of the vehicle 10 and a camera that shoots the road surface on the right side of the vehicle 10 may be installed on the left and right side faces of the vehicle 10, respectively. For example, a plurality of cameras may be installed on the front side of the vehicle 10. For example, the plurality of cameras 3-1 to 3-n may be cameras having different angles of view or resolutions.

In this case, in the road surface information collecting device 1, the image acquiring unit 11 acquires shot images from the plurality of cameras 3-1 to 3-n.

The shot area information acquiring unit 12 acquires shot area information for each of the shot images shot by the plurality of cameras 3-1 to 3-n.

The cameras 3-1 to 3-n assign information capable of specifying the cameras 3-1 to 3-n that shoot the shot image to the shot image and the shooting notifying information, and output the same to the road surface information collecting device 1. Installation positions, angles of view and the like of the cameras 3-1 to 3-n are known in advance.

The shot area information acquiring unit 12 specifies the cameras 3-1 to 3-n that shoot the shot image depending on from which of the cameras 3-1 to 3-n the shooting notifying information is output, and acquires the shot area information for each shot image on the basis of the specified installation positions, angles of view and the like of the cameras 3-1 to 3-n and the current position of the vehicle 10.

In this case also, the shot area information acquiring unit 12 may acquire the current position of the vehicle 10 by acquiring vehicle speed information, and calculating a distance traveled by the vehicle 10 on the basis of the acquired vehicle speed information and an elapsed time from when the current position information of the vehicle 10 is acquired from the GPS 4 last time.

For example, when the vehicle 10 stops at a traffic light or the like, when the image acquiring unit 11 acquires the shot image from the cameras 3-1 to 3-n, this may notify the shot area information acquiring unit 12 that the shot image is acquired, and the shot area information acquiring unit 12 may acquire the shot area information upon receiving the notification.

When managing the shot image output from the image acquiring unit 11 and the shot area information output from the shot area information acquiring unit 12 in association with each other, the image managing unit 13 checks up information capable of specifying the cameras 3-1 to 3-n assigned to the shot image against information capable of specifying the cameras 3-1 to 3-n assigned to the shot area information, and stores the checked shot image and shot area information in the storage unit 14 in association with each other. The image managing unit 13 assigns an image number to the shot image stored in the storage unit 14. It is not essential for the image managing unit 13 to manage which of the cameras 3-1 to 3-n shoots which of the shot image.

As illustrated in FIG. 10, also when the road surface information collecting device 1 is connected to the plurality of cameras 3-1 to 3-n, as is the case of being connected to one camera 3, the road surface information collecting device 1 can achieve the reduction of the communication band caused by upload of the shot image not useful for analysis from the in-vehicle device (road surface information collecting device 1) to the server 2 in the road surface deterioration detecting system 100.

The road surface information collecting device 1 extracts one or more candidate images in which the same area is shot on the basis of the shot area information acquired on the basis of the shot images shot by a plurality of different cameras 3-1 to 3-n, and selects the selected image to be transmitted to the server 2 out of the extracted candidate images. As a result, the road surface information collecting device 1 can select the selected image useful for the road surface deterioration detection processing in the server 2 out of a plurality of shot images having different angles of view, resolutions or the like. When the angle of view, the resolution or the like is different, even if the same road surface deterioration is shot in the shot images, appearance of the road surface deterioration in the shot images is different. The road surface information collecting device 1 can select a more useful selected image by selecting the selected image out of the shot images having different appearance of road surface deterioration as compared with a case of selecting the selected image out of the shot images having the same appearance of road surface deterioration.

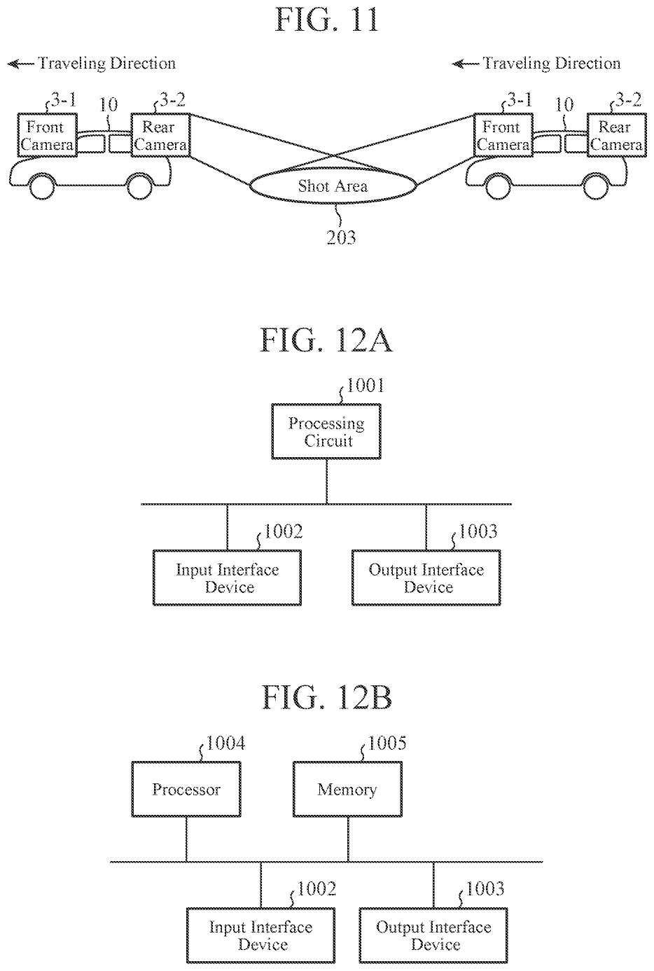

FIG. 11 is a diagram for explaining an example in which the plurality of cameras 3-1 to 3-n shoots the same area when the road surface information collecting device 1 is connected to the plurality of cameras 3-1 to 3-n in the first embodiment.

In FIG. 11, as an example, two cameras, which are a camera (referred to as a front camera) 3-1 that shoots the road surface ahead of the vehicle 10 and a camera (referred to as a rear camera) 3-2 that shoots the road surface behind the vehicle 10, are mounted on the front and rear sides of the vehicle 10, and the road surface information collecting device 1 is connected to the front camera 3-1 and the rear camera 3-2.

For example, w % ben the vehicle 10 travels in a traveling direction, the front camera 3-1 first shoots a certain area (represented by 203 in FIG. 11) on the road surface, and the rear camera 3-2 shoots this certain area after the vehicle 10 passes through this certain area.

When the road surface deterioration is shot in both of the shot image shot by the front camera 3-1 and the shot image shot by the rear camera 3-2, which are the same area images, the road surface information collecting device 1 transmits the shot image having a higher image selecting score to the server 2 as the selected image.

In the first embodiment described above, the image managing unit 13 outputs the extracted candidate image to the image selecting unit 15 every time the candidate image is extracted, but this is merely an example.

For example, the image managing unit 13 may temporarily store the extracted candidate images until all of the candidate images are extracted, and output the stored candidate images to the image selecting unit 15 at one time w % ben all of the candidate images are extracted.

FIGS. 12A and 12B are diagrams illustrating an example of a hardware configuration of the road surface information collecting device 1 according to the first embodiment.

In the first embodiment, functions of the image acquiring unit 11, the shot area information acquiring unit 12, the image managing unit 13, the image selecting unit 15, and the transmitting unit 16 are implemented by a processing circuit 1001. That is, the road surface information collecting device 1 is provided with the processing circuit 1001 for performing control to transmit the shot image acquired by shooting the road surface to the server 2 that detects the road surface deterioration.

The processing circuit 1001 may be dedicated hardware as illustrated in FIG. 12A or a processor 1004 that executes a program stored in a memory as illustrated in FIG. 12B.

When the processing circuit 1001 is the dedicated hardware, the processing circuit 1001 corresponds to, for example, a single circuit, a composite circuit, a programmed processor, a parallel-programmed processor, an application specific integrated circuit (ASIC), a field-programmable gate array (FPGA), or a combination of them.

When the processing circuit is the processor 1004, the functions of the image acquiring unit 11, the shot area information acquiring unit 12, the image managing unit 13, the image selecting unit 15, and the transmitting unit 16 are implemented by software, firmware, or a combination of software and firmware. Software or firmware is described as a program and stored in a memory 1005. The processor 1004 executes the functions of the image acquiring unit 11, the shot area information acquiring unit 12, the image managing unit 13, the image selecting unit 15, and the transmitting unit 16 by reading and executing the program stored in the memory 1005. That is, the road surface information collecting device 1 is provided with the memory 1005 for storing the program which eventually executes steps ST1 to ST5 in FIG. 7 described above when being executed by the processor 1004. It can also be said that the program stored in the memory 1005 causes a computer to execute a procedure or a method of processing performed by the image acquiring unit 11, the shot area information acquiring unit 12, the image managing unit 13, the image selecting unit 15, and the transmitting unit 16. Herein, the memory 1005 is, for example, a non-volatile or volatile semiconductor memory such as a RAM, a read only memory (ROM), a flash memory, an erasable programmable read only memory (EPROM), and an electrically erasable programmable read only memory (EEPROM), a magnetic disk, a flexible disk, an optical disk, a compact disc, a mini disc, a digital versatile disc (DVD) and the like.

Some of the functions of the image acquiring unit 11, the shot area information acquiring unit 12, the image managing unit 13, the image selecting unit 15, and the transmitting unit 16 may be implemented by dedicated hardware and some of them may be implemented by software or firmware. For example, the processing circuit 1001 as the dedicated hardware may implement the functions of the image acquiring unit 11 and the transmitting unit 16, and the processor 1004 may implement the functions of the shot area information acquiring unit 12, the image managing unit 13, and the image selecting unit 15 by reading the program stored in the memory 1005 to execute.

The storage unit 14 uses the memory 1005. This is an example, and the storage unit 14 may be configured by an HDD, a solid state drive (SSD), a DVD or the like.

The road surface information collecting device 1 is provided with an input interface device 1002 and an output interface device 1003 that perform wired communication or wireless communication with a device such as the server or the camera 3.

As described above, according to the first embodiment, the road surface information collecting device 1 includes the image acquiring unit 11 to acquires the shot image of the road surface around the vehicle 10 shot by the shooting device (camera 3) mounted on the vehicle 10, the shot area information acquiring unit 12 to acquire the shot area information regarding the area on the road surface shot in the shot image acquired by the image acquiring unit 11, the image managing unit 13 to extract one or more candidate images acquired by shooting a certain area on the road surface out of the shot images acquired by the image acquiring unit 11 on the basis of the shot area information acquired by the shot area information acquiring unit 12, the image selecting unit 15 to select the selected image to be transmitted to the server 2 out of the candidate images extracted by the image managing unit 13, and a transmitting unit 16 to transmit the selected image selected by the image selecting unit 15 to the server 2. Therefore, the road surface information collecting device 1 can achieve the reduction of the communication band due to the upload of the shot image not useful for analysis from the in-vehicle device to the server.

### Second Embodiment

In the first embodiment, the road surface information collecting device performs the “road surface deterioration detection trial processing” on the candidate image and calculates the image selecting score for the candidate image in which the road surface deterioration is estimated to be shot, and selects the candidate image in which the calculated image selecting score is the highest as the selected image.

In a second embodiment, an embodiment is described in which, when there is a plurality of candidate images in which the image selecting score calculated by a road surface information collecting device is the highest, the road surface information collecting device selects a selected image in consideration of a shooting environment when a camera shoots a road surface.

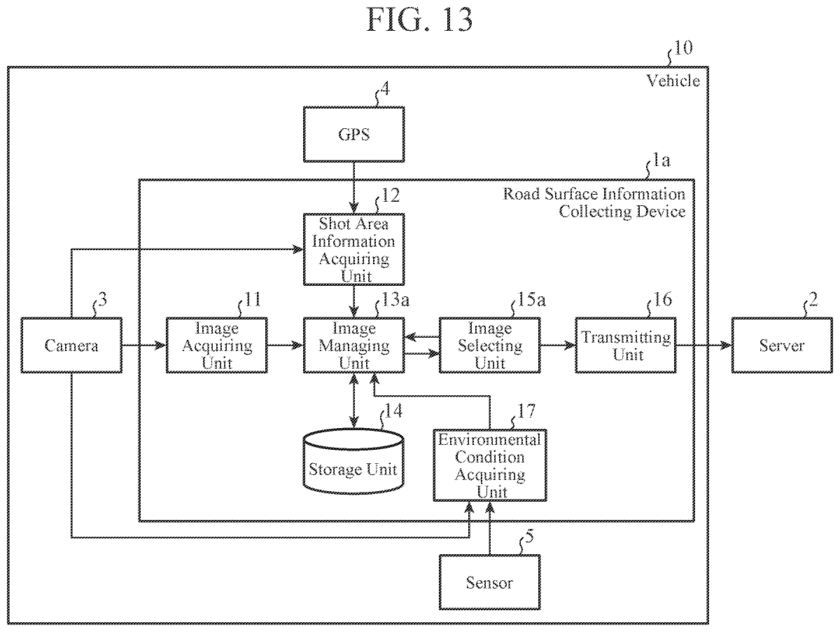

FIG. 13 is a diagram illustrating a configuration example of a road surface information collecting device 1a according to the second embodiment.

A configuration example of a road surface deterioration detecting system 100 according to the second embodiment is similar to the configuration example of the road surface deterioration detecting system 100 described with reference to FIG. 1 in the first embodiment, so that this is not illustrated. In the second embodiment, the road surface information collecting device 1a and a server 2 form the road surface deterioration detecting system 100.

The road surface information collecting device 1a according to the second embodiment is connected to a sensor 5 in addition to the server 2 and a camera 3.

The road surface information collecting device 1a acquires, from the sensor 5, information (hereinafter referred to as an “environmental condition”) regarding a shooting environment when the camera 3 shoots the road surface. In the second embodiment, the shooting environment when the camera 3 shoots the road surface is supposed to be, for example, a vibration state of the camera 3 or brightness around the camera 3. More specifically, the vibration state of the camera 3 is magnitude of vibration of the camera 3.

The sensor 5 is supposed to be a vibration sensor capable of detecting the vibration state of the camera 3, or an illuminance sensor capable of detecting brightness around the camera 3, for example, mounted on the vehicle 10.

The sensor 5 may be connected to the road surface information collecting device 1a directly or via an in-vehicle network.

The road surface information collecting device 1a is connected to one sensor 5 in FIG. 13, but this is merely an example. The road surface information collecting device 1a may be connected to a plurality of sensors 5 and acquire the environmental conditions from the plurality of sensors 5.

In the second embodiment, the sensor 5 is mounted outside the road surface information collecting device 1a, but this is merely an example, and the sensor 5 may be mounted on the road surface information collecting device 1a.

The road surface information collecting device 1a is connected to one camera 3 in FIG. 13, but this is merely an example. The road surface information collecting device 1a may be connected to a plurality of cameras 3 (refer to, for example, FIG. 10 illustrated in the first embodiment).

In the second embodiment, when there is a plurality of candidate images in which the calculated image selecting score is the highest, the road surface information collecting device 1a selects, as the selected image, the candidate image supposed to have a better environmental condition when the camera 3 shoots the candidate image in consideration of the environmental condition acquired from the sensor 5.

Here, the meaning that the road surface information collecting device 1a selects the candidate image supposed to have a better environmental condition as the selected image is described.

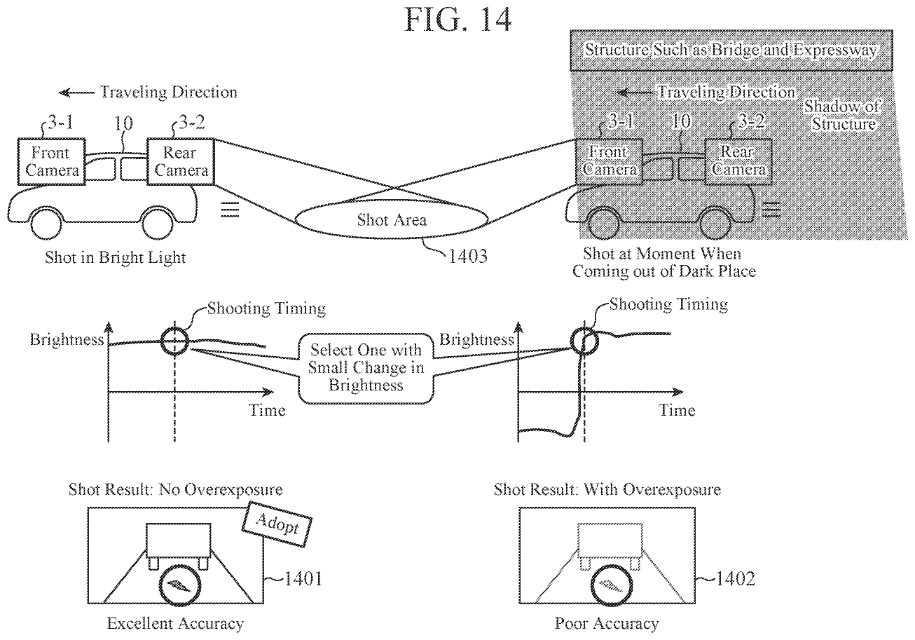

FIG. 14 is a diagram for explaining an example in which the road surface information collecting device 1a selects the selected image out of a plurality of candidate images in which the image selecting score is the highest in consideration of brightness when the camera 3 shoots the road surface as the environmental condition in the second embodiment.

In FIG. 14, for convenience of explanation, it is assumed that the road surface information collecting device 1a is connected to two cameras of a front camera (represented by 3-1 in FIG. 14) that shoots the road surface ahead of the vehicle 10 and a rear camera (represented by 3-2 in FIG. 14) that shoots the road surface behind the vehicle 10.

For example, when the vehicle 10 travels in a traveling direction, the front camera first shoots a certain area (represented by 1403 in FIG. 14) on the road surface, and the rear camera shoots this certain area after the vehicle 10 passes through this certain area. Then, the road surface information collecting device 1a extracts a shot image (represented by 1401 in FIG. 14) acquired by shooting the certain shot area by the front camera and a shot image (represented by 1402 in FIG. 14) acquired by shooting the certain shot area by the rear camera as the candidate images acquired by shooting the same area. Here, the candidate image, which is the shot image acquired by shooting the certain shot area by the front camera represented by 1401 in FIG. 14 is referred to as an “image D”, and the candidate image, which is the shot image acquired by shooting the certain shot area by the rear camera represented by 1402 in FIG. 14 is referred to as an “image E”

Here, it is assumed that road surface deterioration is shot in both the image D and the image E, and when the image selecting score is calculated on the basis of the road surface deterioration, the image selecting score of the image D is equal to the image selecting score of the image E.

However, it is assumed that the front camera shoots the image D in a situation in which the vehicle 10 is not in the shadow of a structure, whereas the rear camera shoots the image E at a moment when the vehicle 10 comes out from a dark place in the shadow of the structure such as a bridge or an expressway and the surroundings become bright.

Then, while the brightness around the front camera is stable before and after a shooting timing of the image D by the front camera, the surroundings of the rear camera suddenly becomes bright before and after a shooting timing of the image E by the rear camera (refer to the middle diagram in FIG. 14).

As a result, actually, overexposure occurs in the image E. and the image becomes a whitish image as a whole. No overexposure occurs in the image D.

In this case, analysis in the road surface deterioration detection processing might be difficult in the image E due to overexposure, and this cannot be said to be a shot image useful for the road surface deterioration detection processing in the server 2.

Therefore, the road surface information collecting device 1a selects the image D, which is the candidate image having a smaller change when the brightness when the camera 3 (the front camera and the rear camera) shoots the road surface is compared with the brightness acquired immediately before, as the selected image.

For example, in consideration of brightness when the camera 3 (the front camera and the rear camera) shoots the road surface, the road surface information collecting device 1a can prevent the candidate image in which overexposure occurs that cannot be said to be the shot image useful for the road surface deterioration detection processing in the server 2 from being selected as the selected image.

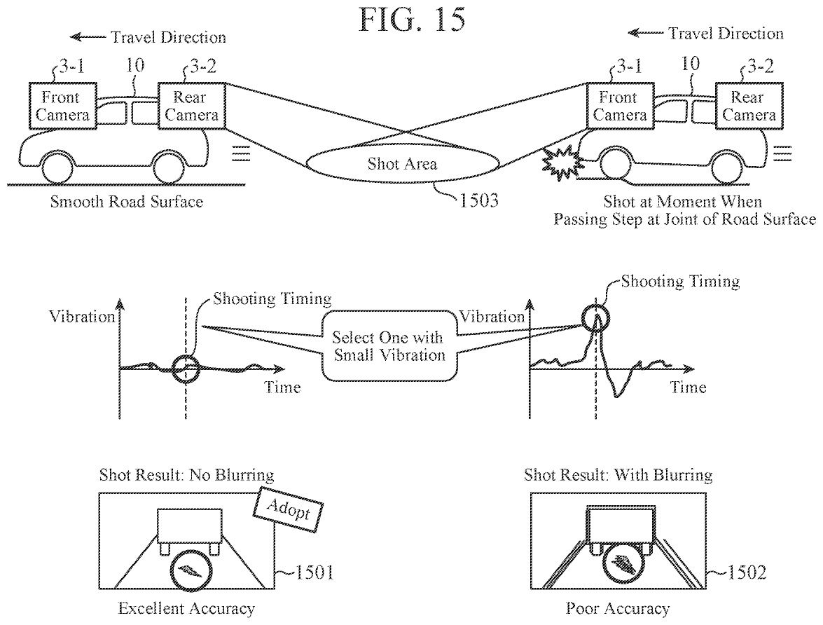

FIG. 15 is a diagram for explaining an example in which the road surface information collecting device 1a selects the selected image out of a plurality of candidate images in which the image selecting score is the highest in consideration of the vibration state of the camera 3 as the environmental condition in the second embodiment.

In FIG. 15, as in FIG. 14, it is assumed that the road surface information collecting device 1a is connected to the two cameras of the front camera and the rear camera.

For example, when the vehicle 10 travels in a traveling direction, the front camera first shoots a certain area (represented by 1503 in FIG. 15) on the road surface, and the rear camera shoots this certain area after the vehicle 10 passes through this certain area. That is, the road surface information collecting device 1a extracts a shot image (represented by 1501 in FIG. 15) acquired by shooting the certain shot area by the front camera and a shot image (represented by 1502 in FIG. 15) acquired by shooting the certain shot area by the rear camera as the candidate images acquired by shooting the same area. Here, the candidate image, which is the shot image acquired by shooting the certain shot area by the front camera represented by 1501 in FIG. 15 is referred to as an “image F”, and the candidate image, which is the shot image acquired by shooting the certain shot area by the rear camera represented by 1502 in FIG. 15 is referred to as an “image G”.

Here, it is assumed that road surface deterioration is shot in both the image F and the image G, and when the image selecting score is calculated on the basis of the road surface deterioration, the image selecting score of the image F is equal to the image selecting score of the image G.

However, it is assumed that the front camera shoots the image F while the vehicle 10 travels on a smooth road surface, whereas the rear camera shoots the image G at a moment when the vehicle 10 passes a step at a joint and the like of the road surface.

Then, while the front camera does not vibrate so much before and after the shooting timing of the image F by the front camera, the rear camera significantly vibrates before and after the shooting timing of the image G by the rear camera (refer to the middle diagram in FIG. 15).

As a result, the image G is actually an image in which blurring occurs. No blurring occurs in the image F.

In this case, analysis in the road surface deterioration detection processing might be difficult in the image G due to blurring, and this cannot be said to be a shot image useful for the road surface deterioration detection processing in the server 2.

Therefore, the road surface information collecting device 1a selects the image F, which is the candidate image having a smaller vibration when the camera 3 (the front camera and the rear camera) shoots the road surface as the selected image.

For example, in consideration of the vibration state of the camera 3 (the front camera and the rear camera) when the camera 3 shoots the road surface, the road surface information collecting device 1a can prevent the candidate image in which blurring occurs and cannot be said to be the shot image useful for the road surface deterioration detection processing in the server 2 from being selected as the selected image.

A configuration of the road surface information collecting device 1a according to the second embodiment illustrated in FIG. 13 is described.

In the configuration of the road surface information collecting device 1a according to the second embodiment, the same configuration as that of the road surface information collecting device 1 described with reference to FIG. 2 in the first embodiment is assigned with the same reference numeral, and redundant description is omitted.

The road surface information collecting device 1a according to the second embodiment is different from the road surface information collecting device 1 according to the first embodiment in providing an environmental condition acquiring unit 17.

Specific operations of an image managing unit 13a and an image selecting unit 15a in the road surface information collecting device 1a according to the second embodiment are different from specific operations of the image managing unit 13 and the image selecting unit 15 in the road surface information collecting device 1 according to the first embodiment.

The environmental condition acquiring unit 17 acquires an environmental condition regarding the surroundings in which the shot image is shot from the sensor 5.

When shooting notifying information is output from the camera 3, the environmental condition acquiring unit 17 acquires the environmental condition from the sensor 5.

In the second embodiment, the camera 3 outputs the shooting notifying information to the shot area information acquiring unit 12 and also outputs the shooting notifying information to the environmental condition acquiring unit 17 at a timing of shooting the road surface around the vehicle 10 and outputting the shot image to the image acquiring unit 11.

The environmental condition acquiring unit 17 outputs information (hereinafter referred to as “shooting environment information”) indicating the shooting environment of the shot image based on the environmental condition acquired from the sensor 5 to the image managing unit 13.

Specifically, for example, when the environmental condition is a value indicating the magnitude of vibration of the camera 3, the environmental condition acquiring unit 17 outputs the value to the image managing unit 13a as the shooting environment information. For example, when the environmental condition is a value indicating the brightness around the camera 3, the environmental condition acquiring unit 17 outputs an amount of change from the value acquired last time to the image managing unit 13 as the shooting environment information. The environmental condition acquiring unit 17 stores the latest environmental condition acquired from the sensor 5. For example, the environmental condition acquiring unit 17 indicates the shooting environment information with a positive value when the value indicating the brightness around the camera 3 acquired from the sensor 5 is larger than the value acquired last time, indicates the shooting environment information with a negative value when the value indicating the brightness around the camera 3 acquired from the sensor 5 is smaller than the value acquired last time, and indicates the shooting environment information with “0” when the value indicating the brightness around the camera 3 acquired from the sensor 5 is not changed from the value acquired last time.

In the second embodiment, the image managing unit 13a manages the shot image output from the image acquiring unit 11, the shot area information output from the shot area information acquiring unit 12, and the shooting environment information output from the environmental condition acquiring unit 17 in association with one another. Specifically, the image managing unit 13a stores the shot image, the shot area information, and the shooting environment information in the storage unit 14 in association with one another.

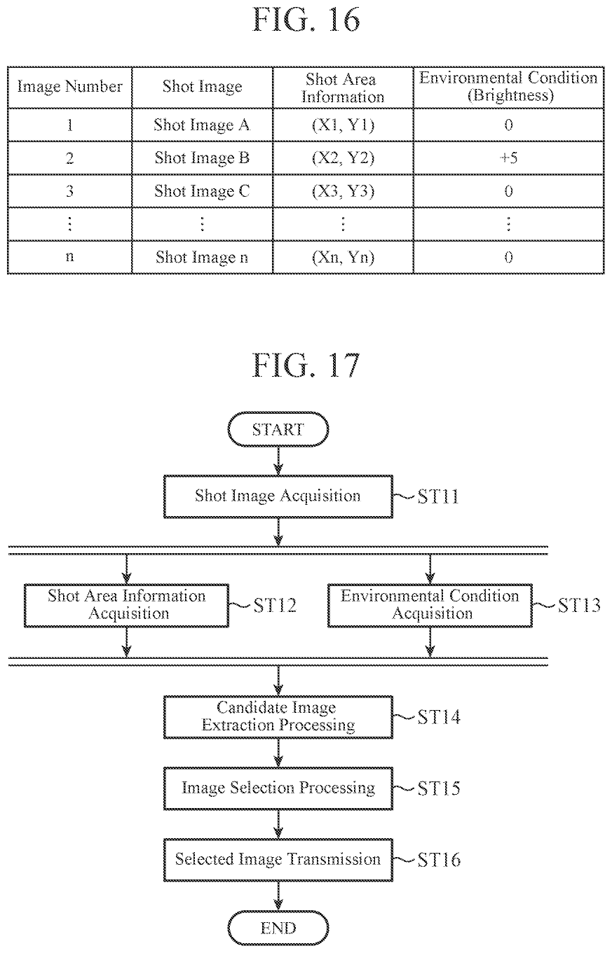

Here, FIG. 16 is a diagram illustrating an example of information stored in the storage unit 14 in the second embodiment.

The image managing unit 13a stores the shot image, the shot area information, and the shooting environment information in the storage unit 14 in association with one another as illustrated in FIG. 16.

In the second embodiment, the information stored in the storage unit 14 by the image managing unit 13a is different from the information stored in the storage unit 14 by the image managing unit 13 illustrated in FIG. 4 in the first embodiment only in that the shooting environment information is associated with the shot image.

In FIG. 16, the shooting environment information is indicated as the environmental condition. In FIG. 16, as an example, the shooting environment information is information indicating the amount of change in brightness around the camera 3.

When there is an image output request from the image selecting unit 15a, the image managing unit 13a extracts the candidate image from the storage unit 14 and outputs the same to the image selecting unit 15a.

The image selecting unit 15a of the second embodiment outputs an image output request signal at a preset cycle, as is the case with the image selecting unit 15 in the first embodiment. When acquiring the image output request signal, the image managing unit 13a determines that there is the image output request from the image selecting unit 15a and extracts and outputs the candidate image.

A specific operation of extracting the candidate image by the image managing unit 13a is similar to the specific operation of extracting the candidate image by the image managing unit 13 in the first embodiment, so that the redundant description is omitted.

Note that, in the second embodiment, when outputting the extracted candidate image to the image selecting unit 15a, the image managing unit 13a outputs the shooting environment information associated with the candidate image together.

In the second embodiment, the image selecting unit 15a selects the selected image to be transmitted to the server 2 out of the candidate images extracted by the image managing unit 13a.

When there is a plurality of candidate images, the image selecting unit 15a performs the “road surface deterioration detection trial processing” for every candidate image to calculate the image selecting score.

The specific operation until the image selecting unit 15a calculates the image selecting score when there is a plurality of candidate images is similar to the specific operation until the image selecting unit 15 calculates the image selecting score in the first embodiment, so that detailed description thereof is omitted.

In the second embodiment, after calculating the image selecting score, the image selecting unit 15a searches for the candidate image in which the calculated image selecting score is the highest, and determines whether or not there is a plurality of candidate images in which the image selecting score is the highest.

When there is a plurality of candidate images in which the image selecting score is the highest, in other words, when there is a plurality of images that can be the selected image on the basis of the image selecting score, the image selecting unit 15a selects the candidate image having the best environmental condition out of the plurality of candidate images in which the image selecting score is the highest as the selected image.

Specifically, the image selecting unit 15a specifies the candidate image having the best environmental condition on the basis of the shooting environment information associated with the candidate image. For example, when the shooting environment information is the shooting environment information indicating the amount of change in brightness around the camera 3, the image selecting unit 15a selects the candidate image having the smallest amount of change in brightness as the selected image. For example, when the shooting environment information is the value indicating the magnitude of vibration of the camera 3, the image selecting unit 15a selects the candidate image having the smallest value as the selected image.

The image selecting unit 15a outputs the selected image that is selected to the transmitting unit 16.

In contrast, when there is not a plurality of candidate images in which the image selecting score is the highest, the image selecting unit 15a selects the candidate image in which the image selecting score is the highest as the selected image.

The image selecting unit 15a outputs the selected image that is selected to the transmitting unit 16.

When there is only one candidate image output from the image managing unit 13a, the image selecting unit 15a performs the “road surface deterioration detection trial processing” on this one candidate image, and when extracting the estimated deteriorated area from the candidate image as a result, this selects this one candidate image as the selected image.

The specific operation in which the image selecting unit 15a selects the selected image when there is only one candidate image is similar to the specific operation in which the image selecting unit 15 selects the selected image when there is only one candidate image in the first embodiment.

The image selecting unit 15a outputs the selected image that is selected to the transmitting unit 16.

An operation of the road surface information collecting device 1a according to the second embodiment is described.

FIG. 17 is a flowchart for explaining the operation of the road surface information collecting device 1a according to the second embodiment.

Specific operations at steps ST11 to ST12 and step ST16 in FIG. 17 are similar to the specific operations at steps ST1 to ST2 and step ST5 in FIG. 7 already described in the first embodiment, respectively, so that redundant description will be omitted.

The environmental condition acquiring unit 17 acquires the environmental condition regarding the surroundings in which the shot image is shot from the sensor 5 (step ST13).

When shooting notifying information is output from the camera 3, the environmental condition acquiring unit 17 acquires the environmental condition from the sensor 5.

The environmental condition acquiring unit 17 outputs the shooting environment information based on the environmental condition acquired from the sensor 5 to the image managing unit 13.

The image managing unit 13a stores the shot image output from the image acquiring unit 11 at step ST11, the shot area information output from the shot area information acquiring unit 12 at step ST12, and the shooting environment information output from the environmental condition acquiring unit 17 at step ST13 in the storage unit 14 in association with one another.

When there is the image output request from the image selecting unit 15a, the image managing unit 13a extracts the candidate image from the storage unit 14 and outputs the same to the image selecting unit 15a (step ST14).

A specific operation of extracting the candidate image by the image managing unit 13a at step ST14 is similar to the specific operation of extracting the candidate image by the image managing unit 13 described with reference to FIG. 8 in the first embodiment, so that the redundant description is omitted.

Note that, when outputting the extracted candidate image to the image selecting unit 15a, the image managing unit 13a outputs the shooting environment information associated with the candidate image together.

The image selecting unit 15a selects the selected image to be transmitted to the server 2 out of the candidate images extracted by the image managing unit 13a at step ST13 (step ST15).

The image selecting unit 15a issues the image output request by outputting the image output request signal to the image managing unit 13a at a preset cycle before performing the processing at step ST15. The image managing unit 13a performs the processing at step ST14 described above in response to the image output request signal.

The image selecting unit 15a outputs the selected image to the transmitting unit 16.

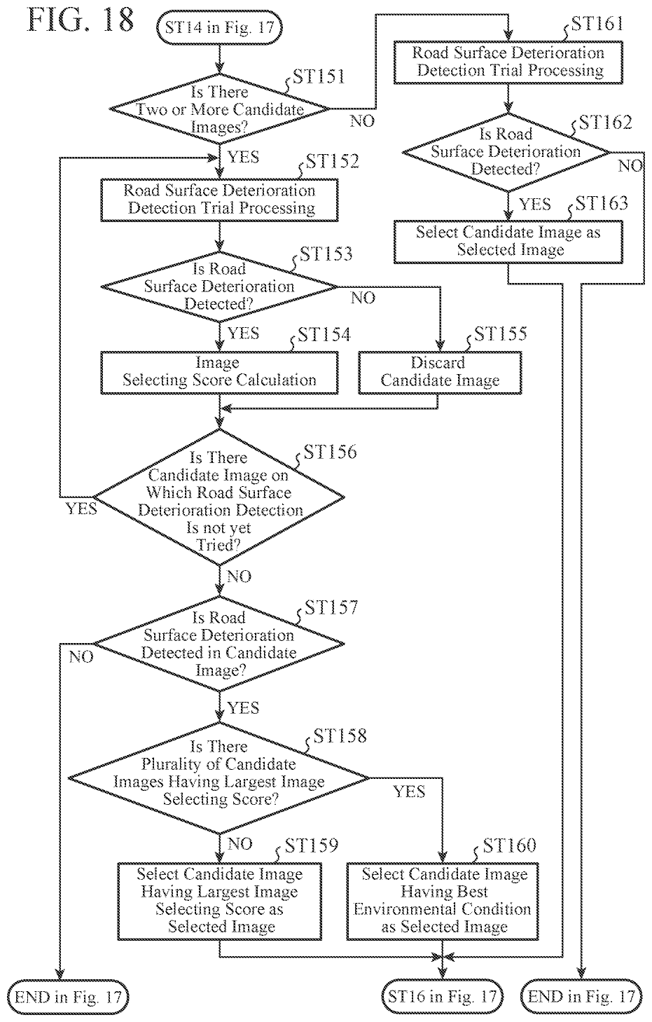

FIG. 18 is a flowchart for explaining in detail an operation of the image selecting unit 15a at step ST IS in FIG. 17.

When the output end signal is output from the image managing unit 13a, the image selecting unit 15a performs processing illustrated in the flowchart in FIG. 18.

Specific operations at steps ST151 to ST157 and steps ST161 to ST163 in FIG. 18 are similar to the specific operations at steps ST41 to ST47 and steps ST49 to ST51 in FIG. 9 already described in the first embodiment, respectively, so that redundant description will be omitted.

When the road surface deterioration is detected in at least one of the plurality of candidate images as a result of performing the “road surface deterioration detection trial processing” on all of the plurality of candidate images, and the image selecting score is calculated for the candidate image from which the estimated deteriorated area is extracted (in a case of “YES” at step ST157), the image selecting unit 15a searches for the candidate image in which the calculated image selecting score is the highest, and determines whether or not there is a plurality of candidate images in which the image selecting score is the highest (step ST158).

When there is a plurality of candidate images in which the image selecting score is the highest (in a case of “YES” at step ST158), the image selecting unit 15a selects the candidate image having the best environmental condition out of the plurality of candidate images in which the image selecting score is the highest as the selected image (step ST160). The image selecting unit 15a outputs the selected image that is selected to the transmitting unit 16.

When there is not a plurality of candidate images in which the image selecting score is the highest (in a case of “NO” at step ST158), the image selecting unit 15a selects the candidate image in which the image selecting score is the highest as the selected image (step ST159). The image selecting unit 15a outputs the selected image that is selected to the transmitting unit 16.

In this manner, when there is a plurality of candidate images in which the calculated image selecting score is the highest, the road surface information collecting device 1a selects the selected image out of the plurality of candidate images on the basis of the environmental condition. Therefore, in the road surface deterioration detecting system 100, the road surface information collecting device 1a can achieve the reduction of the communication band caused by upload of the shot image not useful for analysis in the road surface deterioration detection processing in the server 2 from the in-vehicle device (road surface information collecting device 1a) to the server 2.

Furthermore, the road surface information collecting device 1a can upload a shot image estimated to be more useful in the road surface deterioration detection processing in the server 2 in consideration of the environmental condition.

In the second embodiment described above, the road surface information collecting device 1a acquires the environmental condition from the sensor 5, but this is merely an example.

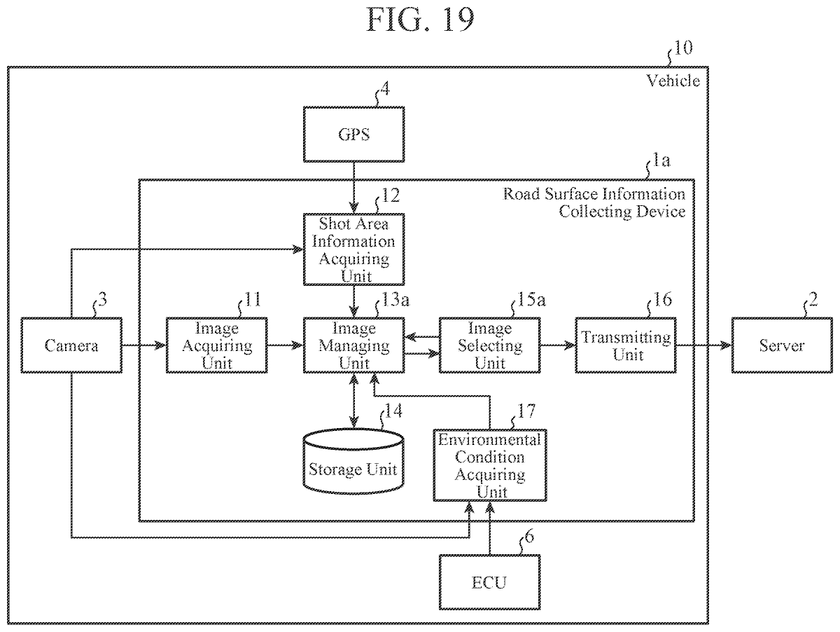

For example, as illustrated in FIG. 19, the road surface information collecting device 1a may be connected to an engine control unit (ECU) 6, and in the road surface information collecting device 1a, the environmental condition acquiring unit 17 may acquire the environmental condition from the ECU 6.

The ECU 6 may be connected to the road surface information collecting device 1a directly or via an in-vehicle network.

The road surface information collecting device 1a may be connected to a plurality of ECUs 6.

Since a hardware configuration of the road surface information collecting device 1a according to the second embodiment is similar to the hardware configuration of the road surface information collecting device 1 according to the first embodiment described with reference to FIGS. 12A and 12B, this is not illustrated.

In the second embodiment, functions of the image acquiring unit 11, the shot area information acquiring unit 12, the image managing unit 13a, the image selecting unit 15a, the transmitting unit 16, and the environmental condition acquiring unit 17 are implemented by the processing circuit 1001. That is, the road surface information collecting device 1a is provided with the processing circuit 1001 for performing control to transmit the shot image acquired by shooting the road surface to the server 2 that detects the road surface deterioration.

The processing circuit 1001 executes the functions of the image acquiring unit 11, the shot area information acquiring unit 12, the image managing unit 13a, the image selecting unit 15a, the transmitting unit 16, and the environmental condition acquiring unit 17 by reading and executing the program stored in the memory 1005. That is, the road surface information collecting device 1a is provided with the memory 1005 for storing the program which eventually executes steps ST11 to ST16 in FIG. 17 described above when being executed by the processing circuit 1001. It can also be said that the program stored in the memory 1005 causes a computer to execute a procedure or a method of processing performed by the image acquiring unit 11, the shot area information acquiring unit 12, the image managing unit 13a, the image selecting unit 15a, the transmitting unit 16, and the environmental condition acquiring unit 17.

The storage unit 14 uses the memory 1005. This is an example, and the storage unit 14 may be configured by an HDD, a solid state drive (SSD), a DVD or the like.

The road surface information collecting device 1a is provided with the input interface device 1002 and the output interface device 1003 that perform wired communication or wireless communication with a device such as the server 2, the camera 3, the sensor 5, or the ECU 6.

As described above, according to the second embodiment, the road surface information collecting device 1a includes the environmental condition acquiring unit 17 to acquire the environmental condition regarding the shooting environment in which the shot image is shot, in which, when there is a plurality of candidate images that can be the selected image on the basis of the calculated image selecting score, the image selecting unit 15a selects the selected image out of the candidate images on the basis of the environmental condition acquired by the environmental condition acquiring unit 17. Therefore, the road surface information collecting device 1a can achieve the reduction of the communication band due to the upload of the shot image not useful for analysis from the in-vehicle device to the server 2. The road surface information collecting device 1a can upload a shot image estimated to be more useful in the road surface deterioration detection processing in the server 2 in consideration of the environmental condition.

The embodiments can be freely combined, any component of each embodiment can be modified, or any component can be omitted in each embodiment.

### INDUSTRIAL APPLICABILITY

The road surface information collecting device according to the present disclosure can achieve the reduction of the communication band due to the upload of the shot image not useful for analysis from the in-vehicle device to the server.

### REFERENCE SIGNS LIST

1, 1a: road surface information collecting device, 2: server, 3: camera, 4: GPS, 5: sensor, 6: ECU, 10: vehicle, 100: road surface deterioration detecting system, 11: image acquiring unit, 12: shot area information acquiring unit, 13, 13a: image managing unit, 14: storage unit, 15, 15a: image selecting unit, 16: transmitting unit, 17: environmental condition acquiring unit, 1001: processing circuit. 1002: input interface device, 1003: output interface device, 1004: processor, 1005: memory

1. A road surface information collecting device mounted on a vehicle to transmit a shot image acquired by shooting a road surface to a server to detect road surface deterioration, comprising:
processing circuitry configured to
acquire the shot image of the road surface around the vehicle shot by a shooting device mounted on the vehicle;
acquire shot area information regarding an area on the road surface shot in the acquired shot image;
extract one or more candidate images acquired by shooting a certain area on the road surface out of acquired shot images on a basis of the acquired shot area information;
select a selected image to be transmitted to the server out of the extracted candidate images; and
transmit the selected image to the server.

2. The road surface information collecting device according to claim 1, wherein
the processing circuitry performs detection processing as to whether or not the road surface shot in the candidate image is deteriorated on the extracted candidate image, and selects the selected image on a basis of a result of the detection processing.

3. The road surface information collecting device according to claim 1, wherein
when there is a plurality of candidate images, the processing circuitry calculates an image selecting score for each of the candidate images, and selects the selected image on a basis of the calculated image selecting score.

4. The road surface information collecting device according to claim 1, wherein
the processing circuitry acquires the shot images shot by a plurality of different shooting devices.

5. The road surface information collecting device according to claim 3,
wherein the processing circuitry is further configured to
acquire an environmental condition regarding a shooting environment in which the shot image is shot, wherein
when there is a plurality of candidate images that serves as the selected image on a basis of the calculated image selecting score, the processing circuitry selects the selected image out of the candidate images on a basis of the acquired environmental condition.

6. The road surface information collecting device according to claim 5, wherein
the shooting environment is a vibration state of the shooting device or brightness around the shooting device.

7. A road surface deterioration detecting system comprising:
the road surface information collecting device according to claim 1; and
the server to analyze the selected image having been transmitted to detect deterioration of the road surface.

8. A road surface information collecting method by a road surface information collecting device mounted on a vehicle to transmit a shot image acquired by shooting a road surface to a server to detect road surface deterioration, comprising:
acquiring the shot image of the road surface around the vehicle shot by a shooting device mounted on the vehicle;
acquiring shot area information regarding an area on the road surface shot in the acquired shot image;
extracting one or more candidate images acquired by shooting a certain area on the road surface out of shot images having been acquired on a basis of the acquired shot area information;
selecting a selected image to be transmitted to the server out of the extracted candidate images; and
transmitting the selected image to the server.
